(19) United States
(12) Patent Application Publication
(10) Pub. No.: US 2019/0311103 A1
(43) Pub. Date: Oct. 10, 2019

(54) Method Performed By A Computer System for Biometric Authentication of Human Beings of a First or a Second Category

(71) Applicant: SAFE PATIENT IDENTIFICATION SWEDEN AB, Halmstad (SE)

(72) Inventors: Rolf M. Skarp, Halmstad (SE); Stig-Arne Svensson, Halmstad (SE)

(21) Appl. No.: 16/461,066

(22) PCT Filed: Apr. 4, 2018
(86) PCT No.: PCT/SE2018/050351

§ 371 Date: May 15, 2019

(30) Foreign Application Priority Data
Apr. 7, 2017 (SE) 1750421-8

(51) Int. Cl. G06F 21/32; G06F 21/34; G06F 3/0481

(52) U.S. Cl. CPC G06F 21/32; G06F 3/0481; G06F 21/34

(57) ABSTRACT

Method performed by a computer system (1) for biometric authentication. The method comprising the steps of retrieving a first fingerprint data (12) alleged to be of the first human (6) and retrieving a second fingerprint data alleged to be of the second human (9). If the retrieving of the first fingerprint data (12) is conducted within a first predetermined time interval (17) from the retrieving of the second fingerprint data (14), comparing the retrieved first fingerprint data (12) and the retrieved second fingerprint data (14) to the stored fingerprint data (8) of the first (6) respectively the second human (9). Providing a positive indication (15) when a match is confirmed for both the first fingerprint data (12) and the second fingerprint data (14) compared to the stored fingerprint data (8) of the first (6) respectively the second human (9).

### TECHNICAL FIELD

The present invention relates to a method performed by a computer system for biometric authentication of human beings of a first or a second category.

### BACKGROUND

First generations of biometric authentication systems have in the last decade been introduced on the global market. These systems have primarily been developed for authentication at a particular geographical place. Recently some mobile computer systems, including laptops and smartphones, also have had biometric authentication devices included in the hardware.

Authentication of at least two human beings belonging to different categories of people, such as a medical doctor vs. a patient, or a dentist vs. a patient, or an examiner/teacher vs. a student, or a courier vs. a recipient of a package/envelope, will in the near future become an important feature of e.g. business activities, the health care system and the educational system.

There are for instance relatively large sums of money lost annually due to insurance fraud in the health care and dental sector, where patient examinations allegedly have been conducted where in reality no such examinations have been conducted. This type of fraud causes further economical strains on the private and/or the tax funded health care and dental system.

Incidents have been revealed where the candidate signing in at an examination in reality has not been the alleged student. This type of fraud undermines the perception and the overall confidence of the scholar system.

Recipients of packages and envelopes claiming to be the true addressee, where in reality this is not true, can cause private and commercial economical losses and further disruption in commercial activities.

There is no biometric authentication system on the market supporting the authentication of at least two human beings belonging to different categories of people at one geographical location at a certain time. The current hardware and software are developed to authenticate one person at a time. These systems do not entirely solve the problem of fraud in the described situations above. Some personnel in the health care and dental sector might for instance by biometric authentication confirm that an examination has been conducted even if this is not correct. There could for instance be economic reasons for triggering this behaviour. Having to provide biometric authentication of both the patient and the medical personnel at one geographical location at the date and time for the alleged examination strongly decreases the risks of fraud.

Biometric authentication by comparing fingerprints is a well proven technique. There are furthermore quite a few different electronic fingerprint readers available on the market.

It is therefore desirable to accomplish a system for biometric authentication of human beings of at least a first and a second category at one geographical location at a certain time. Furthermore the system should use some type of comparison technique of fingerprint data. There should also be additional security features implemented in the solution supporting the described technology.

### SUMMARY OF INVENTION

An objective of the present invention is thus to accomplish a method performed by a computer system for biometric authentication of human beings of a first or a second category at one geographical location at a certain time, which uses some type of comparison technique of fingerprint data and has additional security features implemented in the solution.

According to one aspect, the invention concerns a method performed by a computer system for biometric authentication of human beings of a first or a second category. Wherein the computer system has access to stored unique identifier and fingerprint data of a first human being of the first category and stored unique identifier and fingerprint data of a second human being of the second category. The method comprising the steps of receiving the unique identifier of the first human being at a user interface of a computer, and receiving the unique identifier of the second human being at the user interface of the computer, and retrieving a first fingerprint data at a fingerprint reader of the computer. The first fingerprint data alleged to be of the first human being, and retrieving a second fingerprint data at the fingerprint reader of the computer. The second fingerprint data alleged to be of the second human being, and if the retrieving of the first fingerprint data is conducted within a first predetermined time interval from the retrieving of the second fingerprint data, comparing the retrieved first fingerprint data to the stored fingerprint data of the first human being, and comparing the retrieved second fingerprint data to the stored fingerprint data of the second human being, and providing a positive indication on the user interface of the computer when a match is confirmed for both the first fingerprint data compared to the stored fingerprint data of the first human being, and the second fingerprint data compared to the stored fingerprint data of the second human being.

The fact that there always within a short period of time has to be two human beings of two different categories involved for a biometric authentication to be validated at one geographical location at a certain time, implies that the described method and the social control taking place dramatically decreases the risks of fraud/tampering of the computer/control system. This decreases the risk of potential financial loss in the organisation and/or the society as a whole.

The method above may be configured according to different optional embodiments. For example, wherein in response to a confirmed match for the first fingerprint data compared to the stored fingerprint data of the first human being the method may capture a picture of the confirmed first human being within a second predetermined time interval after the match is confirmed, and store the captured picture in connection with the stored unique identifier and stored fingerprint data of the first human being and possibly also in connection with a time and a date of the capturing.

Capturing a picture of the confirmed first human being will provide the owner of the computer system a further possibility to confirm the identity of the confirmed first human being. It also enhances the possibility that a potential fraudster will not try to be accepted/confirmed as someone else.

Storing the captured picture in connection with the other personal data stored, and possibly also in connection with a time and a date of the capturing, will provide the owner of the computer system a possibility later on in the process to re-confirm that the event has taken place.

According to an embodiment of the invention wherein in response to a confirmed match for both the first fingerprint data compared to the stored fingerprint data of the first human being and the second fingerprint data compared to the stored fingerprint data of the second human being the method may comprise the step of unlocking and/or locking a device that is communicatively connected to the computer system by sending an unlocking signal to the device.

By giving the possibility to unlock/lock a device that is communicatively connected to the computer system by sending an unlocking signal to the device, will for instance give the possibility to unlock/lock medical/dental devices for a certain medical/dental procedure, to unlock/lock doors/gates based on biometrical authentication from at least two human beings, to unlock/lock other technical devices for a certain procedure.

According to an embodiment of the invention wherein for achieving the computer system's access to stored unique identifier and fingerprint data of the first human being of the first category the method may comprise the steps of receiving an indication for adding a unique identifier of the first human being at the user interface of the computer, and receiving the unique identifier of the first human being at the user interface of the computer, and storing the unique identifier of the first human being, and receiving an indication for adding a fingerprint data of the first human being at the user interface of the computer, and retrieving the fingerprint data of the first human being at the fingerprint reader of the computer, and storing the fingerprint data of the first human being in connection with the stored unique identifier of the first human being and possibly also in connection with a time and a date of the retrieving.

By providing the possibility for the computer system to, prior to the described process, receive/collect and store personal data of the first human being supposed to use and be confirmed by the system, the computer system can function as a stand-alone system for covering the full process from collection of biometrical and personal data to confirmation of the alleged first human being by comparison of biometrical and personal data to the stored data.

According to an embodiment of the invention wherein for achieving the computer system's access to stored unique identifier and fingerprint data of the second human being of the second category the method may comprises the steps of receiving an indication for adding a unique identifier of the second human being at the user interface of the computer, and receiving the unique identifier of the second human being at the user interface of the computer, and storing the unique identifier of the second human being, and receiving an indication for adding a fingerprint data of the second human being at the user interface of the computer, and retrieving the fingerprint data of the second human being at the fingerprint reader of the computer, and storing the fingerprint data of the second human being in connection with the stored unique identifier of the second human being and possibly also in connection with a time and a date of the retrieving.

By providing the possibility for the computer system to, prior to the described process, receive/collect and store personal data of the second human being supposed to use and be confirmed by the system, the computer system can function as a stand-alone system for covering the full process from collection of biometrical and personal data to confirmation of the alleged second human being by comparison of biometrical and personal data to the stored data.

According to an embodiment of the invention wherein in response when a match is not confirmed for any of the first fingerprint data compared to the stored fingerprint data of the first human being and the second fingerprint data compared to the stored fingerprint data of the second human being the method may comprise the step of providing a negative indication on the user interface of the computer.

By providing the possibility for the computer system to provide a negative indication on the user interface of the computer, the user will be informed if/when they have been confirmed by the computer system for not being the same/correct human being in comparison to their alleged identity.

According to an embodiment of the invention wherein when the positive indication or the negative indication has been provided the method may comprise the step of storing the positive indication or the negative indication in connection with the stored unique identifiers and the stored fingerprint data of the first and the second human being and possibly also in connection with a time and a date of the comparing.

Storing the positive or the negative indication in connection with the other personal data stored of the user, and possibly also in connection with a time and a date of the capturing, will provide the owner of the computer system a possibility later on in the process to e.g. re-confirm or do statistical analysis on the outcome of the events.

According to one aspect, the invention concerns a computer system for biometric authentication of human beings of a first or a second category. Wherein the computer system has access to stored unique identifier and fingerprint data of a first human being of the first category and stored unique identifier and fingerprint data of a second human being of the second category. Wherein the computer system is arranged to receive the unique identifier of the first human being at a user interface of a computer, and receive the unique identifier of the second human being at the user interface of the computer, and retrieve a first fingerprint data at a fingerprint reader of the computer. The first fingerprint data alleged to be of the first human being, and retrieve a second fingerprint data at the fingerprint reader of the computer. The second fingerprint data alleged to be of the second human being, and if the retrieving of the first fingerprint data is conducted within a first predetermined time interval from the retrieving of the second fingerprint data, compare the retrieved first fingerprint data to the stored fingerprint data of the first human being, and compare the retrieved second fingerprint data to the stored fingerprint data of the second human being, and provide a positive indication on the user interface of the computer when a match is confirmed for both the first fingerprint data compared to the stored fingerprint data of the first human being, and the second fingerprint data compared to the stored fingerprint data of the second human being.

The fact that there always within a short period of time has to be two human beings of two different categories involved for a biometric authentication to be validated at one geographical location at a certain time, implies that the described computer system and the social control taking place dramatically decreases the risks of fraud/tampering of the computer/control system. This decreases the risk of potential financial loss in the organisation and/or the society as a whole.

According to another aspect a computer program comprises computer readable code means, which when run on a computer system causes the computer system to perform the corresponding method.

According to another aspect a computer program product comprises a computer readable medium and a computer program. Wherein the computer program is stored on the computer readable medium.

The computer system may comprise a mobile device, which may include devices such as at least one fingerprint reader, at least one user interface and at least one PCB for data handling. The device may comprise two fingerprint readers, wherein one reader is specifically implemented for the first human being and a second reader is specifically implemented for the second human being. The mobile device may be connected by cable or wireless to the rest of the computer system for transferring of data.

One example for the computer system to be deployed is when a medical doctor is making a home visit at a patient. Personal data, such as fingerprints and unique identifiers, is prior to this visit stored in a central database. A mobile device is then used for selecting unique identifiers and collecting fingerprints from the medical doctor and the patient at site. The collected data is transferred wirelessly from the mobile device to the central server where the comparing step is conducted. A positive or negative indication of a match is transferred from the central server to the mobile device.

Another example for the computer system to be deployed is when a patient visits the dentist. The patient and the dentist can then at the local dentist's surgery make biometric authentications in the same manner as in the example when a patient is visited by a medical doctor at home.

In the method described the human being of a first category may be the patient described above and the human being of a second category may be medical/dental practitioner described above.

The described computer system may not be manipulated by non-authorised personnel, as the user interface of the computer system does not give the possibility to change, delete or manipulate data. The described method further strengthens the case for a non-manipulative system.

The signal used for, unlocking/locking a device that is communicatively connected to the computer system by sending an unlocking signal to the device, could e.g. be of electronic or optical type sent e.g. via cable or by wireless means.

The time and date may be taken from external sources from e.g. the internet and stored centrally. The time and date cannot in the computer system be changed, deleted or altered by non-authorised personnel.

There could also be more than two human beings using the system for a biometric authentication process.

A unique identifier could for instance be a national identification number, a national identity number, a personal identity number, a national insurance number, a national health service number, a social security number, a passport number, a name, an e-mail address, a telephone number among others.

The first predetermined time interval in claim 1 could be any time interval which the organisation determines to be a sufficient time interval for at least two human beings providing their fingerprint data to the system. The predetermined time interval could for instance be 0-60 seconds, among others.

The second predetermined time interval in claim 2 could be any time interval which the organisation determines to be a suitable time interval in between the match is confirmed and for the picture to be taken of the first human being. The second predetermined time interval could for instance be 0-10 seconds, among others.

The capturing of a picture of the confirmed first human being within a predetermined time interval after the match is confirmed could for instance be conducted via a camera connected to the computer.

In claim 1 prior to the retrieving step of the fingerprint data of an alleged first human being at the fingerprint reader of the computer, the following step could be implemented: receiving at the user interface of the computer an indication for retrieving a fingerprint data of the first human being and the second human being.

### BRIEF DESCRIPTION OF DRAWINGS

The invention is now described, by way of example, with reference to the accompanying drawings, in which:

FIG. 1 is a flow chart of a procedure according to an embodiment.

FIG. 2 is a flow chart of a procedure according to an embodiment.

FIG. 3 is a flow chart of a procedure according to an embodiment.

FIG. 4 is a flow chart of a procedure according to an embodiment.

FIG. 5 is a flow chart of a procedure according to an embodiment.

FIG. 6 is a flow chart of a procedure according to an embodiment.

FIG. 7 is a block diagram illustrating, according to a possible embodiment.

FIG. 8 is a block diagram illustrating, according to a possible embodiment.

### DESCRIPTION OF EMBODIMENTS

In the following, a detailed description of a method performed by a computer system for biometric authentication of human beings of a first or a second category is provided.

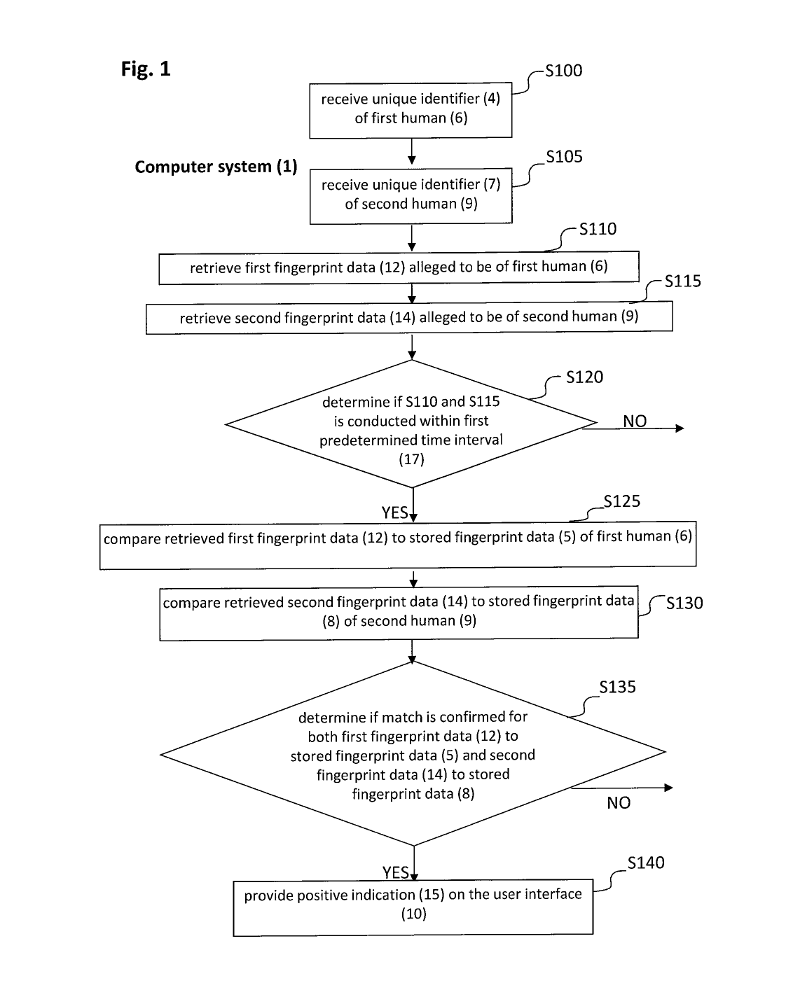

FIG. 1 shows a flow chart illustrating a procedure in a computer system. The various actions may come in different orders than presented in this description, or in a different order than shown in this or other flowcharts related to this description, or some steps may be performed in parallel.

In a step S100 a unique identifier 4 of the first human being 6 is received at a user interface 10 of a computer 11. In a step S105 a unique identifier 7 of the second human being 9 is received at the user interface 10 of the computer 11. In a step S110 a first fingerprint data 12 is retrieved at a fingerprint reader 13 of the computer 11. The first fingerprint data 12 alleged to be of the first human being 6. In a step S115 a second fingerprint data 14 is retrieved at the fingerprint reader 13 of the computer 11. The second fingerprint data 14 alleged to be of the second human being 9. In a step S120 it is determined if the retrieving of the first fingerprint data 12 is conducted within a first predetermined time interval 17 from the retrieving of the second fingerprint data 14. In a step S125 the retrieved first fingerprint data 12 is compared to the stored fingerprint data 5 of the first human being 6. In a step S130 the retrieved second fingerprint data 14 is compared to the stored fingerprint data 8 of the second human being 9. In a step S135 determine if a match is confirmed for both the first fingerprint data 12 compared to the stored fingerprint data 5 of the first human being 6, and the second fingerprint data 14 compared to the stored fingerprint data 8 of the second human being 9. In a step S140 provided a positive indication 15 on the user interface 10 of the computer 11.

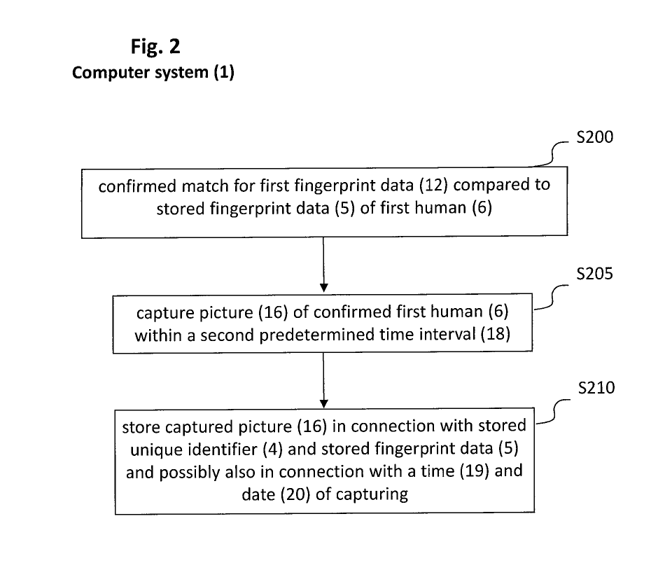

FIG. 2 shows a flow chart illustrating a procedure in a computer system. The various actions may come in different orders than presented in this description, or in a different order than shown in this or other flowcharts related to this description, or some steps may be performed in parallel.

In a step S200 a match for the first fingerprint data 12 compared to the stored fingerprint data 5 of the first human being 5 is confirmed. In a step S205 a picture 16 of the confirmed first human being 6 is captured within a second predetermined time interval 18 after the match is confirmed. In a step S210 the captured picture 16 is stored in connection with the stored unique identifier 4 and stored fingerprint data 5 of the first human being 6 and possibly also in connection with a time 19 and a date 20 of the capturing.

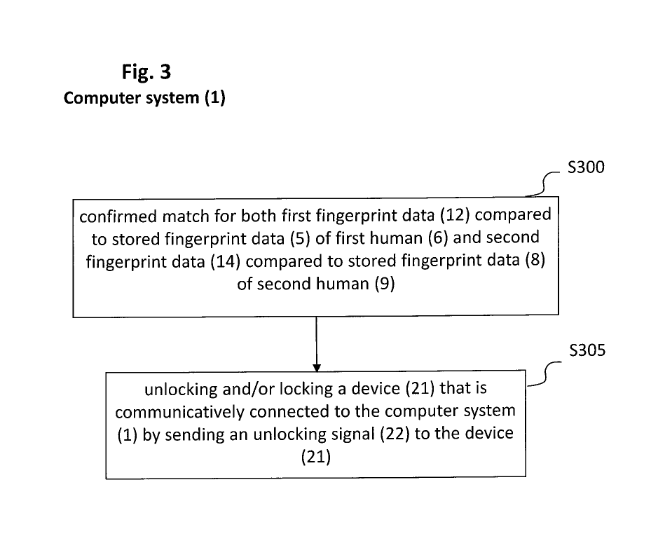

FIG. 3 shows a flow chart illustrating a procedure in a computer system. The various actions may come in different orders than presented in this description, or in a different order than shown in this or other flowcharts related to this description, or some steps may be performed in parallel.

In a step S300 a match for both the first fingerprint data 12 compared to the stored fingerprint data 5 of the first human being 6 and the second fingerprint data 14 compared to the stored fingerprint data 8 of the second human being 9 is confirmed. In a step S305 a device 21 that is communicatively connected to the computer system 1 is unlocked and/or locked by sending an unlocking signal 22 to the device 21.

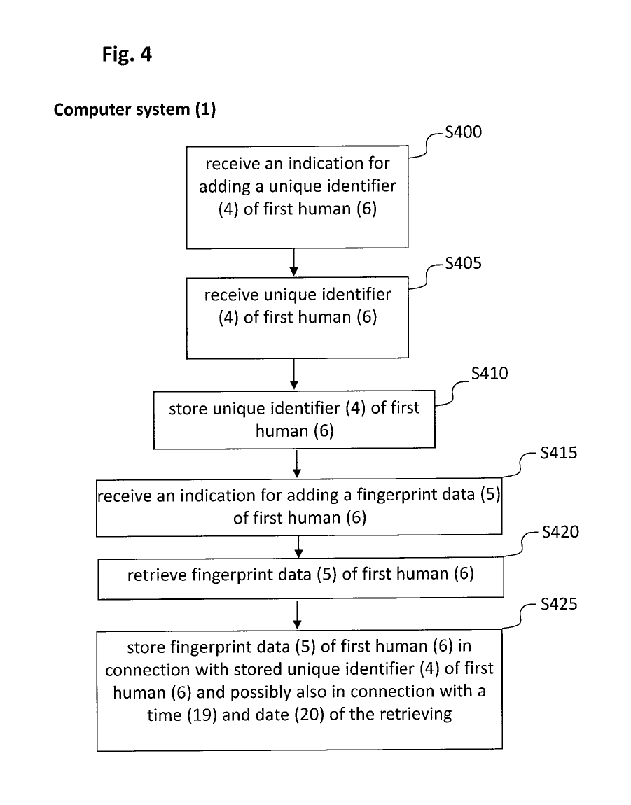

FIG. 4 shows a flow chart illustrating a procedure in a computer system. The various actions may come in different orders than presented in this description, or in a different order than shown in this or other flowcharts related to this description, or some steps may be performed in parallel.

In a step S400 an indication for adding a unique identifier 4 of the first human being 6 is received at the user interface 10 of the computer 11. In a step S405 the unique identifier 4 of the first human being 6 is received at the user interface 10 of the computer 11. In a step S410 the unique identifier 4 of the first human being 6 is stored. In a step S415 an indication for adding a fingerprint data 5 of the first human being 6 is received at the user interface 10 of the computer 11. In a step S420 the fingerprint data 5 of the first human being 6 is retrieved at the fingerprint reader 13 of the computer 11. In a step S425 the fingerprint data 5 of the first human being 6 is stored in connection with the stored unique identifier 4 of the first human being 6 and possibly also in connection with a time 19 and a date 20 of the retrieving.

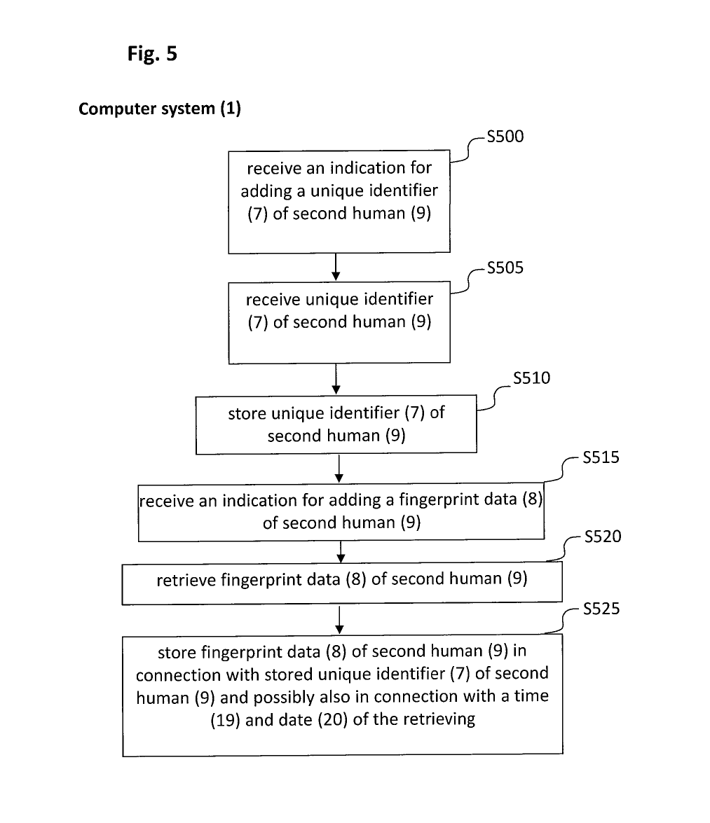

FIG. 5 shows a flow chart illustrating a procedure in a computer system. The various actions may come in different orders than presented in this description, or in a different order than shown in this or other flowcharts related to this description, or some steps may be performed in parallel.

In a step S500 an indication for adding a unique identifier 7 of the second human being 9 is received at the user interface 10 of the computer 11. In a step S505 the unique identifier 7 of the second human being 9 is received at the user interface 10 of the computer 11. In a step S510 the unique identifier 7 of the second human being 9 is stored. In a step S515 an indication for adding a fingerprint data 8 of the second human being 9 is received at the user interface 10 of the computer 11. In a step S520 the fingerprint data 8 of the second human being 9 is retrieved at the fingerprint reader 13 of the computer 11. In a step S525 the fingerprint data 8 of the second human being 9 is stored in connection with the stored unique identifier 7 of the second human being 9 and possibly also in connection with a time 19 and a date 20 of the retrieving.

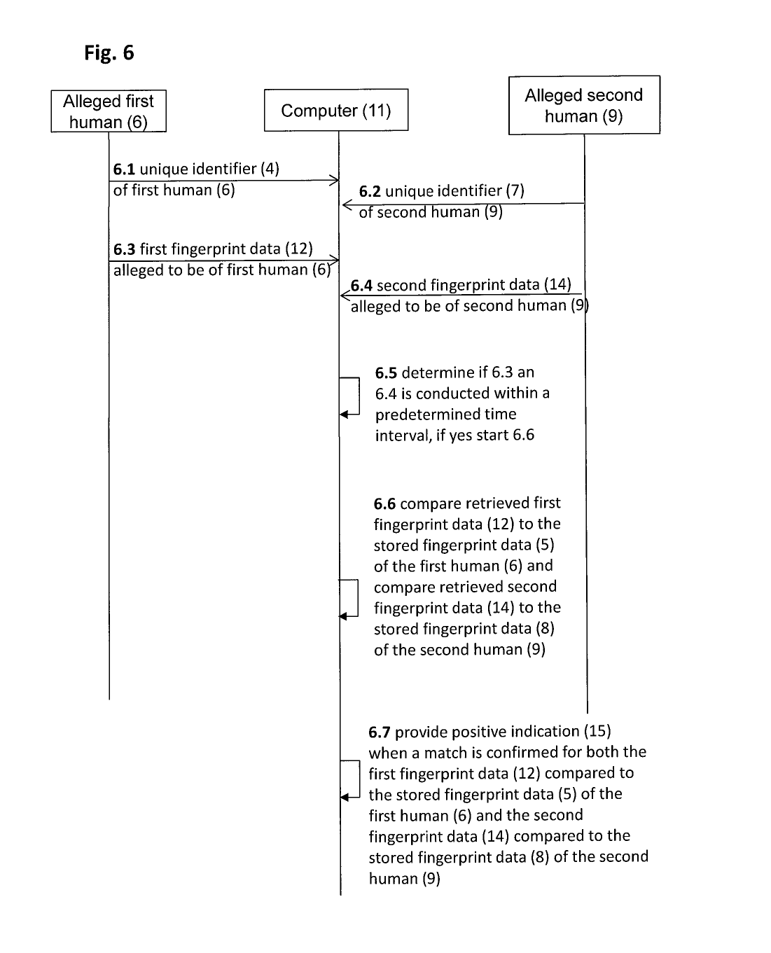

FIG. 6 shows a flow chart illustrating a procedure in a computer system. The various actions may come in different orders than presented in this description, or in a different order than shown in this or other flowcharts related to this description, or some steps may be performed in parallel.

In a step 6.1 a unique identifier 4 of the first human being 6 is received at a user interface 10 of a computer 11. In a step 6.2 a unique identifier 7 of the second human being 9 is received at the user interface 10 of the computer 11. In a step 6.3 a first fingerprint data 12 is retrieved at a fingerprint reader 13 of the computer 11. The first fingerprint data 12 alleged to be of the first human being 6. In a step 6.4 a second fingerprint data 14 is retrieved at the fingerprint reader 13 of the computer 11. The second fingerprint data 14 alleged to be of the second human being 9. In a step 6.5 it is determined if the retrieving of the first fingerprint data 12 is conducted within a first predetermined time interval 17 from the retrieving of the second fingerprint data 14. In a step 6.6 the retrieved first fingerprint data 12 is compared to the stored fingerprint data 5 of the first human being 6. Furthermore the retrieved second fingerprint data 14 is compared to the stored fingerprint data 8 of the second human being 9. In a step 6.7 determine if a match is confirmed for both the first fingerprint data 12 compared to the stored fingerprint data 5 of the first human being 6, and the second fingerprint data 14 compared to the stored fingerprint data 8 of the second human being 9. Furthermore provide a positive indication 15 on the user interface 10 of the computer 11 when a match is confirmed.

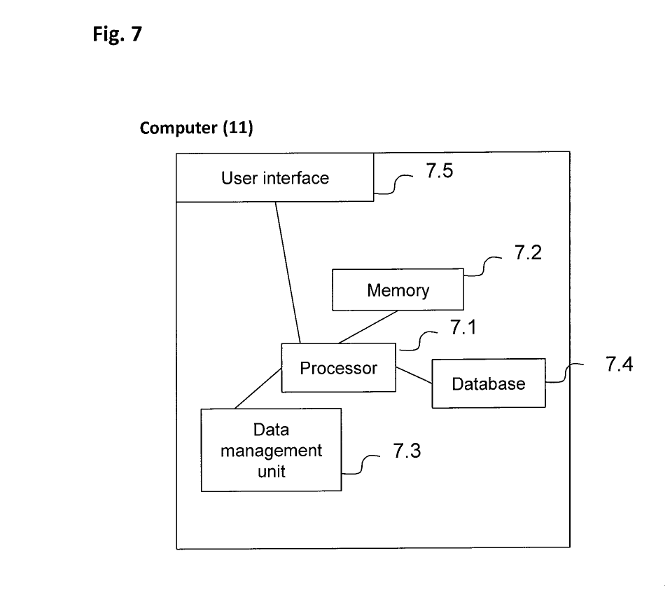

FIG. 7 shows a computer 11, including components such as a processor 7.1, a memory 7.2, a data management unit 7.3, a database 7.4 and a user interface 7.5.

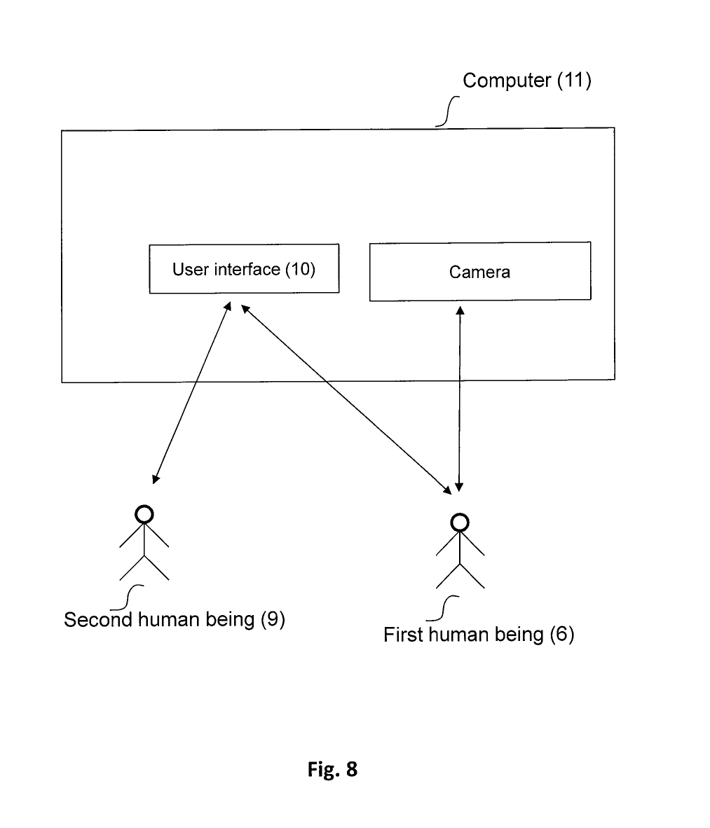

FIG. 8 shows a user interface (10) of the computer (11), a camera connected to the computer (11), a first human being (6) and a second human being (9).

1. A method performed by a computer system (1) for biometric authentication of human beings of a first (2) or a second category (3), wherein the computer system (1) comprises a database, wherein the database comprises stored unique identifier (4) and fingerprint data (5) of a first human being (6) of the first category (2) and stored unique identifier (7) and fingerprint data (8) of a second human being (9) of the second category (3), the method comprising the steps of:
receiving the unique identifier (4) of the first human being (6) at a user interface (10) of a computer (11);
receiving the unique identifier (7) of the second human being (9) at the user interface (10) of the computer (11);
retrieving a first fingerprint data (12) at a fingerprint reader (13) of the computer (11), the first fingerprint data (12) alleged to be of the first human being (6); and
retrieving a second fingerprint data (14) at the fingerprint reader (13) of the computer (11), the second fingerprint data (14) alleged to be of the second human being (9);
wherein if the retrieving of the first fingerprint data (12) is conducted within a first predetermined time interval (17) from the retrieving of the second fingerprint data (14), comparing the retrieved first fingerprint data (12) to the stored fingerprint data (5) of the first human being (6), and comparing the retrieved second fingerprint data (14) to the stored fingerprint data (8) of the second human being (9), and providing a positive indication (15) on the user interface (10) of the computer (11) when a match is confirmed for both the first fingerprint data (12) compared to the stored fingerprint data (5) of the first human being (6), and the second fingerprint data (14) compared to the stored fingerprint data (8) of the second human being (9).

2. The method according to claim 1, wherein in response to a confirmed match for the first fingerprint data (12) compared to the stored fingerprint data (5) of the first human being (6):
capturing a picture (16) of the confirmed first human being (6) within a second predetermined time interval (18) after the match is confirmed; and
storing the captured picture (16) in connection with the stored unique identifier (4) and stored fingerprint data (5) of the first human being (6) and possibly also in connection with a time (19) and a date (20) of the capturing.

3. The method according to claim 1, wherein in response to a confirmed match for both the first fingerprint data (12) compared to the stored fingerprint data (5) of the first human being (6) and the second fingerprint data (14) compared to the stored fingerprint data (8) of the second human being (9), the method further comprises the step of:
unlocking and/or locking a device (21) that is communicatively connected to the computer system (1) by sending an unlocking signal (22) to the device (21).

4. The method according to claim 1, wherein for achieving the computer system's access to stored unique identifier (4) and fingerprint data (5) of the first human being (6) of the first category (2), the method further comprises the steps of:
receiving an indication for adding a unique identifier (4) of the first human being (6) at the user interface (10) of the computer (11);
receiving the unique identifier (4) of the first human being (6) at the user interface (10) of the computer (11);
storing the unique identifier (4) of the first human being (6);
receiving an indication for adding a fingerprint data (5) of the first human being (6) at the user interface (10) of the computer (11);
retrieving the fingerprint data (5) of the first human being (6) at the fingerprint reader (13) of the computer (11); and
storing the fingerprint data (5) of the first human being (6) in connection with the stored unique identifier (4) of the first human being (6) and possibly also in connection with a time (19) and a date (20) of the retrieving.

5. The method according to claim 1, wherein for achieving the computer system's access to stored unique identifier (7) and fingerprint data (8) of the second human being (9) of the second category (3), the method further comprises the steps of:
receiving an indication for adding a unique identifier (7) of the second human being (9) at the user interface (10) of computer (11);
receiving the unique identifier (7) of the second human being (9) at the user interface (10) of the computer (11);
storing the unique identifier (7) of the second human being (9);
receiving an indication for adding a fingerprint data (8) of the second human being (9) at the user interface (10) of the computer (11);
retrieving the fingerprint data (8) of the second human being (9) at the fingerprint reader (13) of the computer (11); and
storing the fingerprint data (8) of the second human being (9) in connection with the stored unique identifier (7) of the second human being (9) and possibly also in connection with a time (19) and a date (20) of the retrieving.

6. The method according to claim 1, wherein in response when a match is not confirmed for any of the first fingerprint data (12) compared to the stored fingerprint data (5) of the first human being (6), and the second fingerprint data (14) compared to the stored fingerprint data (8) of the second human being (9), the method further comprises the step of:
providing a negative indication (25) on the user interface (10) of the computer (11).

7. The method according to claim 1, wherein when the positive indication (15) or the negative indication (25) has been provided, the method further comprises the step of:
storing the positive indication (15) or the negative indication (25) in connection with the stored unique identifiers (4, 7) and the stored fingerprint data (5, 8) of the first (6) and the second human being (9) and possibly also in connection with a time (19) and a date (20) of the comparing.

8. A computer system (1) for biometric authentication of human beings of a first (2) or a second category (3), wherein the computer system (1) has access to stored unique identifier (4) and fingerprint data (5) of a first human being (6) of the first category (2) and stored unique identifier (7) and fingerprint data (8) of a second human being (9) of the second category (3), wherein the computer system (1) is arranged to:
receive the unique identifier (4) of the first human being (6) at a user interface (10) of a computer (11);
receive the unique identifier (7) of the second human being (9) at the user interface (10) of the computer (11);
retrieve a first fingerprint data (12) at a fingerprint reader (13) of the computer (11), the first fingerprint data (12) alleged to be of the first human being (6);
retrieve a second fingerprint data (14) at the fingerprint reader (13) of the computer (11), the second fingerprint data (14) alleged to be of the second human being (9); and
if the retrieving of the first fingerprint data (12) is conducted within a first predetermined time interval (17) from the retrieving of the second fingerprint data (14), compare the retrieved first fingerprint data (12) to the stored fingerprint data (5) of the first human being (6), and compare the retrieved second fingerprint data (14) to the stored fingerprint data (8) of the second human being (9), and provide a positive indication (15) on the user interface (10) of the computer (11) when a match is confirmed for both the first fingerprint data (12) compared to the stored fingerprint data (5) of the first human being (6), and the second fingerprint data (14) compared to the stored fingerprint data (8) of the second human being (9).

9. A computer program, comprising computer readable code means, which when run on a computer system according to claim 8 causes the computer system to perform the method of:
receiving the unique identifier (4) of the first human being (6) at a user interface (10) of a computer (11);
receiving the unique identifier (7) of the second human being (9) at the user interface (10) of the computer (11);
retrieving a first fingerprint data (12) at a fingerprint reader (13) of the computer (11), the first fingerprint data (12) alleged to be of the first human being (6); and
retrieving a second fingerprint data (14) at the fingerprint reader (13) of the computer (11), the second fingerprint data (14) alleged to be of the second human being (9);
wherein if the retrieving of the first fingerprint data (12) is conducted within a first predetermined time interval (17) from the retrieving of the second fingerprint data (14), comparing the retrieved first fingerprint data (12) to the stored fingerprint data (5) of the first human being (6), and comparing the retrieved second fingerprint data (14) to the stored fingerprint data (8) of the second human being (9), and providing a positive indication (15) on the user interface (10) of the computer (11) when a match is confirmed for both the first fingerprint data (12) compared to the stored fingerprint data (5) of the first human being (6), and the second fingerprint data (14) compared to the stored fingerprint data (8) of the second human being (9).

10. (canceled)
